(19) United States
(12) Patent Application Publication
(10) Pub. No.: US 2016/0092891 A1
(43) Pub. Date: Mar. 31, 2016

(54) SYSTEM AND METHOD FOR COLLECTING CONSUMER INFORMATION AND REWARDING CONSUMERS THEREFOR

(71) Applicant: TARTAN CAPITAL LIMITED, Toronto (CA)

(72) Inventor: John Dean FLETT, Toronto (CA)

(73) Assignee: INTEGRATED REWARDS INC., Toronto (CA)

(21) Appl. No.: 14/890,807

(22) PCT Filed: May 23, 2014
(86) PCT No.: PCT/CA2014/000447

§ 371 Date: Nov. 12, 2015

Related U.S. Application Data
(63) Continuation of application No. 13/901,957, filed on May 24, 2013, now abandoned.

(51) Int. Cl. G06Q 30/02; H04L 29/06; G06Q 50/00

(52) U.S. Cl. CPC G06Q 30/0201; G06Q 50/01; H04L 63/10; H04L 63/12

(57) ABSTRACT

A method and system is provided for obtaining, verifying, maintaining and using consumer information of interest including consumer demographic information and consumer transaction information. The information is obtained with the consent and participation of the consumers, which ensures that the resulting databases do not include redundant records, thus reducing the amount of database storage required for the databases and enhancing the ability to search and process the information stored therein. Because consumers provide the system and method with access to their transaction service providers, the system and method can provide the clients of the system with the ability to measure the success of their marketing campaigns using the system.

### RELATED APPLICATIONS

This application claims priority from U.S. patent application, Ser. No. 13/901,957, filed May 24, 2013 and the contents of this earlier application, in its entirety, are incorporated herein by reference.

### FIELD OF THE INVENTION

The present invention relates to a system and method for collecting and using consumer information. More specifically, the present invention relates to a system and method for collecting and using consumer information and for rewarding consumers for the use of their information. A technical effect of the system and method is that the database has verified records for each consumer, increasing the efficiency of the system as redundant records are avoided and incomplete or inaccurate data is avoided. Searches, indexing of the data and general use of the resulting data records is enhanced in efficiency as a more normalized and compact data set is obtained. Further, the system and method include a feedback mechanism, whereby the uptake and/or exploitation of an offer made by a vendor to a consumer member of the system can be tracked and analyzed and used to create improved offers in the future.

### BACKGROUND OF THE INVENTION

Marketing and sales people desire to identify potential customers who have the best chance of buying offered products and/or services. Further, the more marketing and sales people know about a potential customer, the better the sales and marketing efforts can be adjusted to suit the potential customer's needs and wants. In an ideal system, marketing and sales efforts would not be directed to consumers who are not interested in the product or services being offered and consumers would only be shown offers for products and services which they would likely need, or want. Consumers would not be subjected to marketing and sales efforts which are not of interest to them and thus sales and marketing budgets could be more effectively used as effort would not be expended on consumers who will not buy the offered products or services.

In prior attempts to know more about consumers to better market to them, many companies have created loyalty (or reward) programs for consumers to encourage repeat business from the consumers and/or to gather relevant information about the participating consumers. Such loyalty programs can be offered by particular service providers (such as airlines or gasoline companies, etc.) and provide rewards to consumers who repeatedly use those service provider's services, or by credit card companies or the like who provide rewards for consumer's purchases with their credit cards. Rewards can comprise free, or discounted, services or products, special offers, etc.

While such loyalty programs are widespread, they are limited to providing only a small view of the consumers' purchasing habits and demographics. For example, a gasoline company loyalty program only provides information with respect to the consumer's purchase of gasoline and related products, while a credit card loyalty program only provides information with respect to the consumers' purchases with that credit card. Thus, existing consumer information and loyalty program systems may suffer from a technical challenge in that any wide scale loyalty program may contain multiple records for a single consumer, i.e.—one record for their gas company loyalty program, another record for their airline loyalty program, etc., each record requiring additional space in a database system. Combining these multiple records into a single consistent set of data records may not be possible as the identity of the consumer in a case may not correspond well to the identity of the consumer in other cases. These multiple records require additional storage space and processing power to use and maintain. At least as problematic is the fact that multiple records can also prevent a marketing company or the like from gathering the desired complete picture of their target consumer, as the various records may not be linked to the consumer in any easily knowable way and, even if they are, it will require additional computing resources to process the multiple records.

Further, additional limitations exist as many governments have enacted, or plan to enact, privacy legislation which can restrict the collection of data about a consumer and the uses that data can be put to. Perhaps even more problematic is that, even in the absence of such legislation, many consumers fear or resent the collection of data about them and may avoid participating in programs which collect such data because of such fears or resentments.

In view of the above, it is desired to have a system and method of collecting and using a comprehensive set of consumer information which will not offend participating consumers, which can be technically implemented in an efficient manner and which can allow for the improved marketing and sales of products and services to those consumers, in many cases with a feedback mechanism, indicating the success of the marketing and sales efforts.

### SUMMARY OF THE INVENTION

It is an object of the present invention to provide a novel system and method for collecting and using consumer information, and rewarding consumers therefor, which obviates or mitigates at least one disadvantage of the prior art.

According to a first aspect of the present invention, there is provided a method for collecting and using records of consumer information, where that information is verified for each consumer and the formation of redundant records is inhibited, comprising the steps of: (i) creating an account for at least one consumer in a record in a demographic database, the account including demographic information relating to the at least one consumer and identifying at least one transaction service provider used by the at least one consumer; (ii) obtaining authorization from the at least one consumer to utilize the provided demographic information and to obtain transaction information relating to transactions made by the at least one consumer via the identified at least one transaction service provider and to store that transaction information in a record in a transaction database; (iii) in return for compensation from an entity, allowing that entity to specify criteria to define consumers of interest and to examine the records in the demographic database and the transaction database to identify consumers meeting the specified criteria; (iv) forwarding information from the entity to the identified consumers; and (v) providing compensation to each identified consumer.

According to another aspect of the present invention, there is provided a system for collecting and using records of consumer information which is verified for each consumer to inhibit the formation of redundant records, comprising: a consumer demographic database operable to receive and store records of demographic information relating to consumers participating in the system including, for each consumer, the identity of at least one transaction service provider used by the consumer; a transaction database operable to receive and store records of transaction information, received from the transaction service providers identified in the consumer demographic database, for each participating consumer; a data mining engine operable to, in response to an input data query, access information in records of the consumer demographic database and records of the transaction database to identify participating consumers who meet the conditions of the data query; and a compensation engine cooperating with the data mining engine to assign compensation to participating consumers identified by the data mining engine in response to the data query.

The present invention provides a method and system for obtaining, maintaining and using consumer information of interest to sales and marketing entities, the information preferably including consumer demographic information and consumer transaction information. The information is obtained with the consent and participation of the consumers who are compensated for the use of their information. The system and method can obtain information directly from the consumers and from a variety of transaction service providers that the consumer interacts with or through.

By having explicit participation from the consumers and the consumers' consent to use the information, and by compensating the consumers for the use of their data, it is believed that a more comprehensive and better quality data set will be obtained than that available from other consumer information systems. Preferably, the compensation to the consumers can be based upon each use of their data and thus compensation can be paid multiple times for the same data and compensation may be earned over extended time periods, thus encouraging consumers to continue their participation in the system and method.

### BRIEF DESCRIPTION OF THE DRAWINGS

Preferred embodiments of the present invention will now be described, by way of example only, with reference to the attached Figures, wherein:

FIG. 1 shows a block diagram of a consumer transaction network, including a consumer data collection service in accordance with the present invention;

FIG. 2 shows a block diagram of the consumer data collection service of FIG. 1; and

FIG. 3 shows a flowchart of a method of a consumer establishing and maintaining an account with the consumer data collection service of FIG. 2.

### DETAILED DESCRIPTION OF THE INVENTION

As discussed above, loyalty programs and the like are widely employed in an attempt to reward a consumer's continued purchase of a product or service from a particular supplier and to collect information about the consumer which can be used in attempts to improve marketing and/or sales to that consumer.

Such loyalty programs typically require the consumer to sign up for the program and to then present their loyalty card, or number, at each specific consumer transaction to allow the loyalty card system to capture information about the transaction. If the consumer fails to provide their loyalty program information at the time of the transaction, no information is captured about the transaction. Statistics on such loyalty programs show that information is not captured from a significant number of transactions due to the consumer forgetting about, or losing interest in, their participation in the loyalty program.

One significant technical challenge with such systems is that a single consumer likely participates in multiple loyalty programs, to various extents, and thus has multiple data records storing the relevant information about their behaviors and previous activities. While there would be clear advantages to having a single record of behaviors for a consumer, both in terms of data storage space savings and also the usefulness that a more complete and consistent record of the consumer's behavior for marketing analysis and use, it is often difficult or impossible to reliably combine data records from multiple, diverse systems into a single useful record with any degree of confidence.

Further, consumers are increasingly reluctant to have information about themselves collected by third parties and, in many cases, the scale of the rewards offered to the consumer for the collection are not significant enough to the consumer to maintain the consumer's interest and participation in the program.

Other methods of collecting consumer information are also known. For example, credit card companies can track the purchasing habits of their customers and use that information to cross-sell additional and/or alternative services to those consumers. In another example, some businesses now operate post-purchase surveys wherein the business encourages its customers into participating in a survey, typically offered online, by offering the chance to win a prize to those participating.

These and many other methods of collecting consumer information have had limited success and, more recently, may be severely limited in efficacy, or be curtailed altogether, due to data privacy laws and consumer protection laws which have been implemented in many jurisdictions.

A further significant technical challenge to such systems is that, to date, it has proven difficult or impossible to obtain anything but the most limited feedback on the success of marketing efforts using loyalty program data. Typically, such loyalty program systems tend to be open loop programs where, at best, sales are monitored after a marketing program has been implemented in an attempt to determine the success, or lack thereof, of marketing efforts using the loyalty program data.

Further, a critical flaw with existing loyalty programs is that they only deal with/consider existing customers of the loyalty program operator and do not assist marketers in obtaining new customers.

The inventor of the present invention believes that there is a place for a system and method which collects information about consumers, with their permission, and which appropriately rewards those consumers for the collection and use of that information. Ideally, the system and method would operate across many types of consumer transactions, covering the multiple credit cards and/or loyalty cards that a consumer holds, and including other useful methods of recognizing consumer activities, rather than being limited to information obtained through a single credit card or loyalty card and would allow for feedback regarding the success, or lack thereof, of marketing and sales efforts made using the information. Also, the system can provide feedback, comprising data regarding consumer actions that may result from the uptake of offers and/or marketing campaigns initiated through the system, which will allow marketers and clients of the system to assess the success of their campaigns.

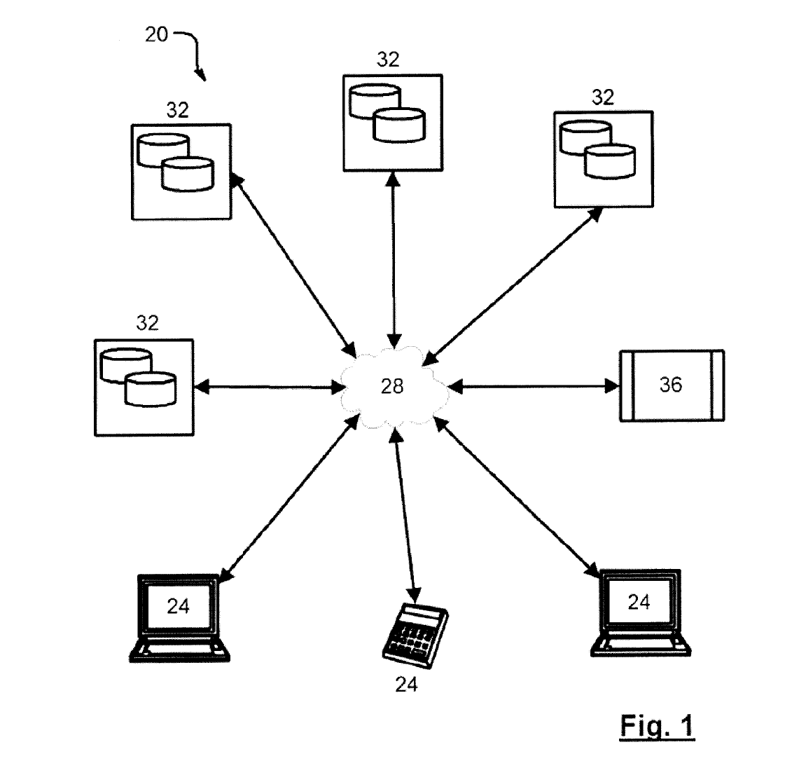

FIG. 1 shows a consumer transaction network 20 for use with the present invention. Consumer transaction network 20 comprises a variety of point of sale data capture points 24, such as cash registers, credit and debit card machines, ATMs, ecommerce web pages, etc., each of which is connected to a data communications network 28.

Data communications network 28 can be the Internet or a private data communications network or any combination of the Internet and other public or private networks.

Sales data capture points 24 communicate, through network 28, with one or more transaction service providers 32 which participate in the transactions at the point of sale, either by providing payment for the transaction or by otherwise capturing details of the transaction for various purposes such as existing loyalty reward programs.

Transaction service providers 32 can include credit card service providers (i.e.—Mastercard™, Visa™, Discover™, etc.); debit card service providers (i.e.—financial institutions, Interac™ network members, etc.); electronic payment systems (i.e.—Paypal™, Ecash systems, digital wallets, etc.); loyalty card service providers; etc. It is further contemplated that transaction service providers 32 can include social media services, such as Facebook and/or Twitter which can provide API's for information relating to the consumers' interests, preferences, etc.

It is also contemplated that transaction service providers 32 can include data aggregator services such as MINT™ which can aggregate banking, credit card and other financial information for a consumer and which can then provide that aggregator set of data.

For ecommerce, social media services or other online transactions, a participating consumer can install a monitoring and reporting application on their web device (personal computer, smartphone, tablet, etc.), which will provide relevant transaction information to system 20. In some cases, web sites and services provide specific API's (application program interfaces) which allow 3^{rd} parties to access relevant transaction information. Non-limiting examples of relevant information can include the URLs of web pages visited by the consumer, the links to other pages or web sites on the visited pages that the consumer selected, the time the consumer spent on a web page, etc.

Such a monitoring and reporting application can be provided to the consumer as part of their participation in system 20 and, as described below, the consumer can be appropriately compensated for their installation and use of the monitoring and reporting application. It is contemplated that the consumer will be able to easily deactivate and reactivate the reporting and monitoring application, as desired, to enable the consumer to switch as desired between private web browsing and monitored web browsing.

A consumer data collection service 36, in accordance with the present invention, communicates with transaction service providers 32 to collect and organize data regarding consumer activities, as described further below.

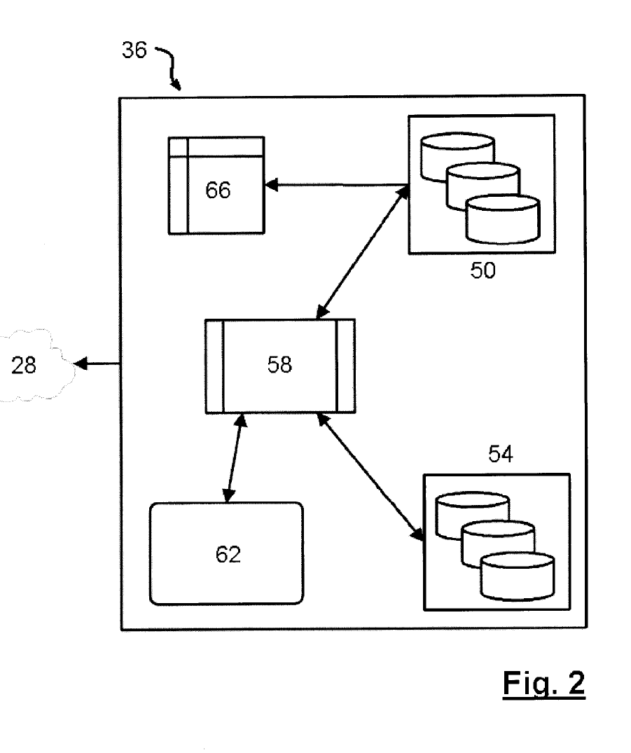

FIG. 2 shows consumer data collection (“CDC”) service 36 in more detail. CDC service 36 comprises a consumer demographic database 50 and transaction database 54.

Consumer demographic database 50 can be any suitable database program executing on a general purpose computer system, or on a special purpose database computer system or appliance, as desired. Consumer demographic database 50 receives and stores demographic information about consumers who have joined a consumer information program implemented on CDC service 36. Consumer demographic database 50 also stores information about the rewards/compensation earned by the consumers, as described below in more detail.

Transaction database 54 can be any suitable database program executing on a general purpose computer system, or on a special purpose database computer system or appliance, as desired. Transaction database 54 receives and stores transaction information about consumers participating in the consumer information program, reported by transaction service providers 32.

As will be apparent to those of skill in the art, consumer demographic database 50 and/or transaction database 54 can also be implemented on computer systems operated by CDC service 36, or on virtual machines, either operated by CDC service 36 or leased from so-called “cloud” service providers, such as Amazon's EC2 service or the like.

The present invention is not limited to any particular implementation or hosting arrangement for consumer demographic database 50 or transaction database 54 and a wide range of useful configurations will occur to those of skill in the art and such are intended to be within the scope of the present invention. Also, it is contemplated that in some cases the dataset in transaction database 54 can include one or more databases maintained by transaction service providers 32 and to which CDC service 36 is provided access, as needed.

As shown in FIG. 2, CDC service 36 further includes a data mining engine 58, a compensation engine 62 and a consumer web portal 66. Data mining engine 58 can be any suitable program enabling data mining of large data sets and can, for example, be implemented using Apache Hadoop or any other suitable technology as will occur to those of skill in the art. Accordingly, data mining engine 58 can be implemented on one or more general purpose computing systems or on one or more virtual machines, etc.

Compensation engine 62 comprises a suitable program, executing on one or more general purpose computer systems or the like, which enables the processing of one or more defined compensation schemes for use of information within CDC service 36, as described further below.

Consumer web portal 66 comprises a web server and/or other suitable information server, executing on one or more general purpose computer systems or virtual machines. Consumer web portal 66 allows participating consumers to review and, to some extent modify or update, demographic information stored about them in consumer demographic database 50 and to review the compensation awarded to them by compensation engine 62. Consumer web portal 66 can be accessed by consumers via a secure web page, or via a dedicated application, such as a so-called “app” executing on a smartphone or other mobile computing device.

As should be apparent to those of skill in the art, the specific hardware and software used to implement system 20 is not particularly limited and a wide variety of suitable configurations and arrangements can be employed without departing from the scope of the present invention.

A presently preferred embodiment of the invention requires that a consumer who wishes to participate in CDC service 36 will first create an account in consumer demographic database 50. This account can be created in a variety of manners, such as by having the consumer fill in a form comprising demographic and other desired information and submitting that completed form to the operator of CDC service 36 for input into consumer demographic database 50. More preferably, the consumer can access consumer web portal 66 via a web enabled computer, or mobile device, and can follow an appropriate process, such as completing a series of web forms, to create an account and to populate it with demographic and other relevant information.

It is contemplated that each consumer account will include at least a required minimum of demographic information provided by the consumer. This minimum demographic information set could, for example, include name, address, email address, gender and age of the respective consumer. The consumer will also be requested to provide information to identify transaction service providers 32 relevant to the consumer, such as the information required to identify the credit cards held by the consumer, loyalty accounts held by the user, banking information (and debit card) information for the consumer, social media accounts, electronic payment accounts, etc. At this time, the consumer may also be offered the opportunity to download and install the above-mentioned monitoring and reporting application for one or more of their web enabled devices.

Most importantly, the consumer will be required to authorize the collection and use, by CDC service 36, of the demographic information provided by the consumer and the collection and use of information about the consumer's transactions obtained from the transaction service providers 32 (credit card companies, banks, loyalty programs, data aggregator services, etc.) identified by the consumer. This authorization will preferably be submitted by the consumer through consumer web portal 66 but, it is also contemplated that, depending upon the jurisdiction and the nature of the transaction service provider 32 (bank, loyalty program, etc.), the authorization(s) may require the consumer to print out and sign an authorization form which is then mailed or delivered to the relevant transaction service provider 32 and/or to CDC service 36. It is also contemplated that, for some transaction service providers 32, the authorization may comprise the consumer providing their username and password for that transaction service provider 32, which allows CDC service 36 to obtain data from that particular transaction service provider 32 via a web portal or other online service normally made available to the consumer by the transaction service provider 32. For example, a bank may allow its customers to access their account information via an online banking web service and the consumer can provide their username and password to CDC service 3 to allow CDC service 36 to obtain their account information as needed.

However the necessary authorizations are obtained, these authorizations allow CDC service 36 to request, or otherwise be provided with, information about the transactions of the consumer involving the transaction service providers 32 identified by the consumer. For example, if the consumer has identified a credit card that they use and authorized CDC service 36 to obtain transaction information from that credit card, CDC service 36 will inform the relevant credit card company that CDC service 36 has been authorized to access transaction information relating to the use of that credit card by the consumer.

Different transaction service providers 32 can make different types of information available to CDC service 36. For example, a transaction service provider 32 for electronic payments may only be able to provide information about the date of the payment, the identity of the payee and the amount of the payment. In contrast, a transaction service provider 32 for credit cards may provide additional details of the transaction, including in some cases an identification of the actual product or service that was bought.

It is contemplated that, depending upon the transaction service provider 32 and the nature of the transaction, CDC service 36 may be required to purchase the transaction data from the transaction service provider 32, or otherwise compensate the transaction service provider 32, or may be provided with the transaction data for free. In any case, the transaction data can be proactively sent from the identified transaction service providers 32 to CDC service 36 at appropriate times, or can be requested or otherwise obtained from the identified transaction service providers 32 by CDC service 36, as needed.

One of the important aspects of the present invention is that consumers are compensated for the use of their transaction information. Further, with the present invention, a consumer can participate in CDC service 36 to various extents, as they desire. Thus, a consumer may limit the information provided to CDC service 36, if they desire, and this will likely limit the compensation they receive from CDC service 36. For example, a consumer may identify to CDC service 36 the credit card that they use for business travel and expenses, but may omit the credit card that they use for personal purchases. In such a case, the compensation they earn, as further discussed below, will likely be reduced from that which they would have earned if both credit cards had been identified to CDC service 36 but their personal transactions will not be provided to CDC service 36. Thus, a consumer can participate in CDC service 36 to the extent that they feel comfortable with and such “tiered” participation will result in different levels of compensation to the consumer.

In addition to permitting the consumer to “tier” their participation by including and/or excluding information about their transaction service providers 32, it is also contemplated that the user-supplied demographic information can be tiered as well. CDC service 36 can have a minimum set of required consumer demographic information, as mentioned above, as well as optional “enhanced” demographic information where, when a consumer chooses to provide enhanced demographic information, the compensation they earn can be correspondingly increased.

Specifically, any consumer who wishes to participate in CDC service 36, and be compensated therefor, will be required to provide the minimum demographic information, for example: name; mailing address; gender; marital status; and age. Enhanced demographic information can include information such as: employment status; home telephone and/or cellular telephone numbers; total household income; past credit history; religion; race; residence details (i.e.—whether the consumer lives in a house, condo or apartment and whether the house or condo is rented or owned); etc.

It is contemplated that enhanced demographic information can be tiered as well, with corresponding differences in earned compensation. For example, one contemplated tier can be that the required and/or enhanced demographic information is at least partially verified by, for example, the consumer authorizing a credit bureau report to be obtained by CDC service 36 to verify the relevant information submitted by the consumer. Another tier of enhanced demographic information can be the consumer volunteering to install an application on their mobilephone (or other device) that reports their current location to CDC service 36 and allowing CDC service 36 to use that information.

With the present invention, the participation by consumers is voluntary. Thus the level, or tier, to which a consumer participates is voluntary, and can be changed by the consumer as desired. It is therefore possible for a consumer to first establish their account with CDC service 36 at one tier of participation and to subsequently increase, or decrease, that level of participation. For example, a consumer can “test” their participation in CDC service 36 by providing the minimum demographic information and only identifying one of their transaction service providers 32 (i.e.—a single credit card).

After becoming more comfortable with CDC service 36 and/or receiving compensation from CDC service 36, the consumer can opt to identify to CDC service 36 one or more additional transaction service providers 32 and/or to provide some level of enhanced demographic information. As should be apparent, the intent is that the compensation provided to consumers will be sufficient to encourage them to increase the level of their participation with CDC service 36 and that it will be apparent to the participating consumers that, by adding additional transaction service providers 32, installing a reporting and monitoring application, providing additional demographic information, etc., their earned compensation will be appropriately increased.

However, it is also contemplated that, a consumer can decide that they do not wish transaction information to be collected from a previously identified transaction service provider 32 and can remove that transaction service provider 32 from their account information with CDC service 36 and CDC service 36 will then stop collecting transaction data for that consumer from that transaction service provider 32.

In either case, the change in the consumer's tier of participation will likely result in a change in the future compensation of the consumer by CDC system 36.

It is also contemplated that additions and amendments to the types of consumer demographic information collected and maintained by CDC service 36 can be driven by requests from the marketing and sales users (the clients of CDC service 36) of the information provided by CDC service 36.

For example, a variety of clients may believe that a significant demographic factor in targeting marketing to consumers is identifying consumers who regularly travel for an annual vacation. In such a case, those clients may request that CDC service 36 identify and maintain such information about the consumers in consumer demographic database 50 and CDC service 36 can request that its consumer participants add such information to the demographic information in their account.

Depending upon the information requested and the clients' level of interest in the information, each consumer who responds to this request may be directly compensated for their providing the desired information, or the consumers may do so merely in the hopes that their chance of receiving compensation, and/or the level of that compensation, will be enhanced by their providing the requested information. Details of the compensation of participating consumers are discussed further below.

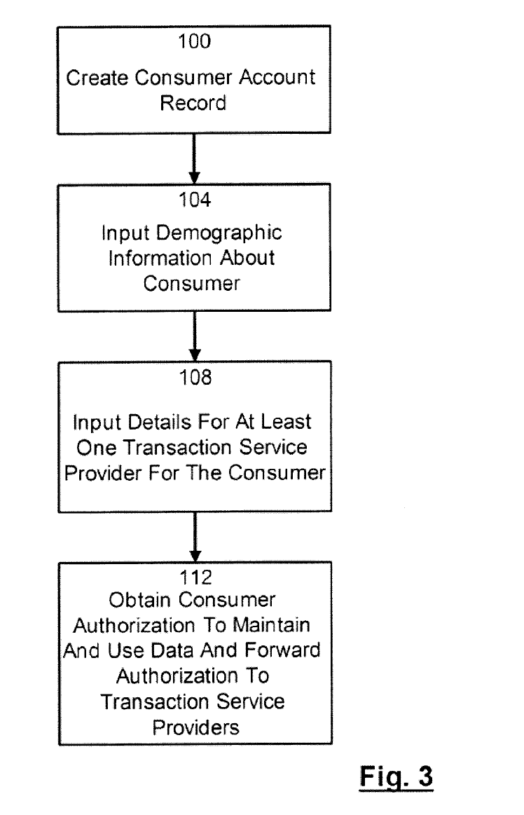

FIG. 3 shows a flowchart of an example of a method of a consumer joining CDC service 36. In this example, the process commences at step 100 where the consumer creates an account record. It is contemplated that the step will preferably be performed online, via the consumer accessing an appropriate web site such as consumer web portal 66, and creating an account and defining a password for that account. However, it is also contemplated that the account record can be created via a variety of other methods, including the consumer completing a suitable set of printed forms and delivering those completed forms to an office of CDC service 36 where a data entry clerk, or the like, will create the consumer account for the consumer.

At step 104, the consumer inputs at least a predefined minimum of demographic information, for consumer demographic database 50. As described above, preferably the detail level of the consumer demographic information can be tiered and, in such a case, the consumer will be presented with options as to what level of demographic information they wish to provide to CDC service 36 at this time.

At step 108, the consumer inputs data to define at least one transaction service provider 32 for the consumer, for consumer demographic database 50. Preferably, as part of this process the consumer will be prompted as to the range of transaction service providers 32 (e.g.—credit card companies, bank accounts, E payment providers, digital wallet service providers, loyalty program memberships, social media accounts, etc.) which are of interest to CDC service 36 to remind the consumer of all relevant transaction service providers 32 they might include in their account information.

The method completes at step 112, where the consumer provides authorization to CDC service 36 to maintain and use the demographic information provided at step 104 and for CDC to obtain transaction data from the transaction service providers 32 identified at step 108. It is contemplated that, in many cases, the authorizations obtained from the consumer will be forwarded to the relevant transaction service providers 32 by CDC service 36. However, it is also contemplated that some transaction service providers 32 (e.g.—financial institutions, etc.) may require direct authorization from the consumer. In such cases, CDC service 36 can provide the necessary forms or contact information to the consumer, as part of step 112, and CDC service 36 will await confirmation from the consumer or transaction service provider 32 that authorization has been received. In other cases, the authorization may comprise the consumer providing CDC service 36 with the consumer's username and password (or equivalents) to sign into web portals provided by a transaction service provider 32 from which CDC service 36 can obtain the desired information.

While the method of FIG. 3 is one method by which a consumer can join CDC service 3, it should be apparent to those of skill in the art that a wide variety of alternative methods can also be employed to enable a consumer to join CDC service 36, as desired.

As is discussed above, it is contemplated that consumers will wish to add additional demographic information to their account, from time to time, and/or to add additional transaction service providers 32. In such cases, consumers can subsequently re-perform steps 104, 108 and 112 as needed to update their information.

Because participation by consumers in CDC service 36 spans across transaction service providers 32 and is voluntary and authorized by the consumers themselves (who are compensated for their participation and who can provide detailed demographic information about themselves) it is contemplated that the data available from CDC service will be of a higher quality than consumer data available from many other sources. Also, again as the participation by the consumers in CDC service 36 is voluntary and compensated, spans multiple transaction service providers, can include enhanced demographic data, can be maintained on a long term basis and can provide feedback on the activities of consumers in CDC service 36, it is contemplated that clients of CDC service 36 will find a higher level of success with their marketing efforts directed to consumers identified by CDC service 36.

Further, because of the participation of the consumers in setting up their accounts and specifying their transaction service providers 32, the creation of redundant, misidentified and/or partial data records for consumers can be reduced or, in some cases, eliminated. This results in CDC service 36 having a smaller, more normalized, database than would otherwise be the case and allows more efficient storage of the data, along with more efficient searching, indexing and use of the data.

It is also contemplated that consumers can update their demographic data, from time to time, to “self elect” themselves within various groups for which they are interested in seeing offers. For example, a consumer who expects to be in the market for a new car, sometime within six months, maybe specifically identify themselves as such by opting in to a predefined “New Car Buyers” group. Similarly, a pregnant woman may opt in to an “Expectant Mothers” group. In both cases, the consumer is providing enhanced demographic data by voluntarily identifying themselves as being interested in offers relevant for a particular group of consumers.

It is thus contemplated that data mining engine 58 can include a set of common predefined groups and that consumers can opt in to, or out of, such predefined groups as desired, through appropriate pages of consumer web portal 66. It is also contemplated that the creation and deletion of such predefined groups can be dynamic, to provide relevant groups as needed, as needed and that consumer web portal 66 will allow consumers to suggest new groups of interest to them.

CDC service 36 can process requests from clients (i.e.—marketing firms, sales agencies, product vendors, etc.) to identify consumers that meet criteria of interest to the clients. For example, a home owner's insurance company can request the identification of consumers who own their home and who hold a valid credit card. The identification of such a targeted marketing group is somewhat conventional and may well be available from a variety of sources. More interestingly, the home owner's insurance company can request from CDC service 36 the identification of consumers who meet more specific criteria, such as: own their home; who have spent at least a specified minimum amount at a home renovation goods supplier in each of the last three years; and have posted comments about their home renovation on social media sites. Such a target group may correspond to a new marketing plan proposed by the insurance company (e.g.—to identify consumers who have renovated their homes to increase their value and who may now be underinsured) and which could not, without CDC service 36, be easily identified or targeted. As will be apparent to those of skill in the art, the range of queries that can be made against a comprehensive data set, such as that maintained in consumer demographic database 50 and transaction database 54, to specify target marketing groups and identify the consumer members of those groups is virtually unlimited. Perhaps even more interesting is the ability of clients to identify new groups of consumers to whom their marketing efforts can be directed.

For example, with the comprehensive data set maintained in consumer demographic database 50 and transaction database 54, a client can perform data mining to first identify consumers who have already purchased the service or product of interest to the client (e.g.—home owner's insurance) and to then look for transactions in transaction database 54 (e.g.—spent over $ X dollars at a home renovation supplier in each of the last three years) and information in consumer demographic database 50 (between the ages of 30 and 42) which is similar for a statistically significant number of the identified customers. In such a case, the client of CDC service 36 may identify these criteria as defining a new group of interest to the client and the client can run additional queries using this criteria to find consumers who may be interested in purchasing home owner's insurance.

As another example, a client of CDC service 36 who sells luggage can perform data mining to identify consumers who take more than one vacation trip each year with the cost of the vacation in excess of a threshold amount (e.g.—$5000) and who have spent more than a threshold amount (e.g.—$1000) on clothing purchases in the past 6 months. The client may believe that such consumers offer the best target demographic for its new luggage offerings.

Perhaps even more interestingly, CDC service 36 can employ predictive analytics to suggest categories/groups of consumers that a client of CDC service 36 may wish to direct offers to, or design campaigns for. Specifically, CDC service 36 can determine consumers who have met some desired goal within a previous timeframe (e.g.—“have a bought a new car within the last six months”). CDC service 36 will then examine the consumer data of each of those identified consumers to attempt to identify common characteristics of those consumers and CDC service 36 can use those identified characteristics to form a suggested grouping (e.g.—“people looking to buy a new car”) of other consumers in CDC service 36. Access to such a suggested grouping can then be offered to appropriate clients (i.e.—car manufacturers, auto insurance companies, etc.) of CDC service 36.

Such predictive analytics can also be employed to form groups of consumers in CDC service 36 who have previously responded to specific incentives. For example, CDC service 36 can offer to a client of CDC service 36 access to a group of consumers who have previously acted upon a coupon offer, or an offer of reward points, etc. to complete a purchase as part of a directed marketing campaign.

Further, CDC service 36 will be able to construct suggested groups of interest to particular clients of CDC service 36, for example CDC service 36 will be able to determine the group of consumers in CDC service 36 who have spent more than a specified amount at a particular merchant within a specified time, i.e.—the people who spent more than $5000 at a home renovations vendor within the last six months. Such suggested groups will be of particular interest to that merchant and/or its competitors.

It is also contemplated that clients of CDC service 36 will be able to perform data mining operations to assess the success of their marketing activities. For example, a client of CDC service 36 may offer a subset of consumers a discount on their service/product and a different subset a chance to win a trip or other prize if they purchase the product/service. In such a case, the client can then examine transaction records for each subset of consumers to assess which marketing campaign had the greater impact.

Similarly, other clients can perform data mining queries to assess the success of their, or their competitors', marketing and sales campaigns. In particular, the technical challenge of obtaining feedback to assess the success of a marketing campaign can, for the first time, be achieved with relative simplicity with the present invention.

In the simplest case, a client can implement a direct marketing campaign for a target group of consumers identified by CDC service 36 and can then, by subsequently examining data from corresponding transaction service providers 32, determine which of those targeted consumers have participated in the campaign.

Such feedback can be obtained for campaigns directed to specified large groups of interest (i.e.—home owners) and to specialized small groups (i.e.—home owners who live within ten kilometers of a particular store) or even groups of one consumer.

Specifically, when a marketing offer is made to a consumer within a group of interest via CDC system 36, the uptake of the offer can be determined by watching for a corresponding transaction occurring at one of that consumer's transaction service providers 36. For example, the success of a directed marketing offer for a discount on new luggage made to the group of consumers identified above (i.e. consumers who take more than one vacation trip each year with the cost of the vacation in excess of a threshold amount (e.g.—$5000) and who have spent more than a threshold amount (e.g.—$1000) on clothing purchases in the past 6 months) can be determined by examining the transaction service providers 36 for the consumers in the group to identify purchase of the offer made within the group. Similarly, if the offer to the consumers in the group included an online discount voucher, or a coupon, the use of the voucher or coupon can be determined and included as feedback to the marketer.

It is contemplated that, with the present invention these feedback mechanisms can uniquely enable near real time correction and/or enhancement of direct marketing programs. Specifically, a marketer can launch an offer/program and can monitor its success in near real time (dependent upon the processing speed and update times of the various transaction service providers 32 to which CDC system 36 has access) and, if the desired level of consumer takeup has not occurred within some time period, the offer/program can be modified in an attempt to improve the takeup.

For example, the luggage offer mentioned above could initially comprise a 15% discount on the offered luggage. If, after some period of time, the marketer examines the feedback data and determines that only 5% of the target group has taken advantage of the offer, instead of the desired 20%, then the marketer can update the offer to increase the discount to 25%. This process can be performed on an iterative basis, as needed, for the marketer to achieve its desired goal.

To process requests received from clients, it is contemplated that CDC service 36 can receive those requests and appropriately input those requests into data mining engine 58 as necessary. In such a case, it is contemplated that CDC service 36 will maintain a team of data mining professionals who will perform such operations with data mining engine 58 as a paid service to clients of CDC service 36.

It is also contemplated that, in some circumstances, clients of CDC service 36 will be able to directly interact, through data communications network 28, with data mining engine 58 to process their queries themselves. As will be apparent to those of skill in the art, such communications will be protected by suitable encryption methods and client authentication systems. It is contemplated that such queries from sophisticated clients of CDC Service 36 can be constructed in SQL or other database query language, while for less technologically skilled clients of CDC service 36, such queries can be constructed via a set of drop down menu selections, or the like, or via similar simplified query construction methods as may be offered to those clients via a suitable web portal, etc.

CDC service 36 can charge the client an appropriate amount for providing relevant CDC service 36 data and compensation will be paid to consumers participating in CDC system 36 for the use of their data as described further below. The amount charged, and paid to the consumer, can depend upon the complexity of the data mining query required by a client.

In a presently preferred embodiment of the invention, the identities of consumers in CDC system 36 are preferably not directly shared with clients of CDC system 36. This is intended primarily to provide an additional level of assurance to consumers that their demographic information and captured transaction data will not be misused (for example by preventing a client of CDC service 36 from reselling information obtained from CDC service 36 to other marketing organizations or other interested parties).

Instead, in the presently preferred embodiment of the invention, communications from clients of CDC service 36 to relevant consumers will pass through CDC service 36, maintaining the anonymity of the consumers. Thus, in the examples of the home owner's insurance company mentioned above, CDC service 36 will inform the insurance company client that “X” number of consumers have been determined as meeting the client's specified criteria. The client can then provide the desired marketing materials for those X determined consumers to CDC service 36 who will forward the marketing materials to the determined consumers for an appropriate fee.

If the marketing materials/package are printed materials, CDC service 36 can have the provided printed materials mailed to the determined X consumers. If the marketing materials are electronic, CDC service 36 can have the materials emailed to the determined X consumers, or forwarded to their social media accounts, as appropriate. If the marketing materials are to be delivered via a telephonic marketing campaign, CDC service 36 can arrange to connect the appropriate marketing call center to the determined consumers.

A variety of other methods by which CDC service 36 can interpose itself between the determined consumers and the clients of CDC service 36 will be apparent to those of skill in the art and are intended to be within the scope of the present invention.

As mentioned above, CDC service 36 compensates participating consumers for the use of their demographic and transaction data stored in CDC service 36. The range of compensated data, amounts of compensation and the types of compensation provided to participating consumers within CDC service 36 can vary widely. In a presently preferred implementation of the invention, for many types of usage of their data, consumers are compensated, either in cash, reward points equivalent, redeemable vouchers, etc., with a percentage of the fees paid to CDC service 36 by clients of CDC service 36.

For example, in the above-mentioned example of the company selling luggage attempting to identify, with a known query, consumers who may be interested in purchasing new luggage, CDC service 36 may receive $0.05 per consumer lead provided to the luggage company. In such a case, those consumer leads may be credited compensation, for example, with a value of $0.01, either in cash or in reward points which the consumer may accumulate and redeem as desired.

As another possible example, in the case described above of the home owner's insurance company performing data mining to identify criteria to define new possible consumer groups of interest to market to, each consumer in CDC system 36 who owns their own home may have been employed in the data mining operations and CDC service 36 may have received $2,000 for the data mining services to identify the new criteria of interest. In this case, compensation equivalent to $200 of the $2,000 received may be divided equally amongst all consumers whose data was employed in the data mining operation.

In another compensation aspect, if the consumer has opted to include a monitoring and reporting application on their web-enabled device, that application can provide data to CDC service 36 and/or to existing services, such as Google's Ad Words system, to assist in the selection and display of appropriate onscreen advertisements on that web-enabled device. In such cases, the consumer would receive compensation for the display of those advertisements. Similarly, if the consumer has opted to include a location tracking application on their mobile device, they can be compensated for any location-related advertisements that are provided to them.

A variety of other compensation models can be employed, as will be apparent to those of skill in the art. For example, a consumer may be compensated for receiving an offer from a merchant. The consumer could also be compensated a second time, perhaps to a greater extent, if they act upon the offer.

Also, as mentioned above, certain consumer activities may be compensated directly by CDC service 36. For example, a consumer who provides the highest tier level of demographic information about themselves may be compensated some amount by CDC service 36. Similarly, a consumer who identifies a specific transaction service provider 32 (e.g.—a social media account), of particular interest to CDC service 36, on their demographic information may be compensated some amount by CDC service 36.

It is presently preferred that consumers in CDC service 36 be compensated for each new use of their demographic and transaction related information. For example, in one of the above-mentioned home owner's insurance company examples, a consumer who meets the criteria of owning their home and having spent a preselected amount on renovations would be compensated for that use of their data. However, a lawn care service company may also wish to identify consumers who own their own home and spend to maintain their home and/or to demonstrate pride in their home via social media and the same consumer will be compensated again by CDC service 36 if the lawn services company pays to access that data.

As should now be apparent, in such a compensation plan, a consumer can be compensated multiple times for the use of their data and can be compensated at a variety of different times for data obtained by CDC service 36. As an example of the later case, a consumer may purchase their home renovation supplies in one year, and be compensated for the use of that information by the clients of CDC service 36 in that year and also be compensated some years later when other clients of CDC service 36 use that information for a different query.

It is also contemplated that, in at least some embodiments of the present invention, if CDC service 36 is involved in forwarding communications from clients to participating consumers (such as the above-mentioned mail or email distribution of marketing materials from clients to participating consumers) that CDC service 36 can provide some compensation to those participating consumers. Essentially, in such a case the clients of CDC service 36 will be compensating the participating consumers for receiving their marketing materials.

It is contemplated that such a compensation method will encourage continued participation by consumers as, in many cases, they will see their rate of compensation increase over time and this will assist in preventing consumers from losing interest in participating in CDC service 36. Specifically, in many circumstances, the consumers' compensation will include compensation related to recent transactions and compensation for transactions they may have made in previous time frames, even years before. Thus, their rate of compensation can increase over time, even though their number of transactions may not increase.

While the examples above mainly referenced a monetary compensation, the present invention is not so limited and, instead, it is contemplated that a wide range of types of compensation can be employed as desired. Such compensation types can include the award of “points” from CDC service 36, which points can be redeemed by the consumer for goods and/or services; the award of points for a loyalty program offered by a client of CDC service 36; the award of points or credits for a social media service; the award of discount coupons or special offers, etc. Those of skill in the art of loyalty and/or reward programs will recognize a variety of other compensation schemes and methods that can be employed with the present invention and such schemes and methods are intended to be within the scope of the present invention.

Another form of compensation for participating consumers is that, because their interests and preferences are better documented and/or described in CDC service 36, the marketing and sales materials they receive for campaigns using CDC service 36 will typically have more relevance to the consumer than materials from other campaigns. Thus, they will receive less “junk mail” or other non-relevant sales and marketing materials.

Compensation engine 62 operates in conjunction with data mining engine 58 to identify and track the usage of the data of participating consumers in CDC system 36. Compensation engine 62 can be implemented as custom software executing on a general purpose computing device or in any of a wide variety of other manners as will occur to those of skill in the art.

Compensation engine 62 can employ a wide range of techniques to decide that a consumer's data has been used by a client of CDC service 36. In a simple case, each consumer identified as the result of a client query processed by data mining engine 58 can be deemed to have had their data used and can be assigned appropriate compensation.

In another case, data mining engine 58 can construct and maintain virtual groups of consumers who meet certain preselected criteria of common interest (i.e.—homeowners; consumers with total family incomes in excess of a specified value; etc.) and any use of such a virtual group in a client query can be deemed a use of the data of all members of the virtual group.

In another case, compensation can be assigned to participating consumers who have at least a predefined number of transactions added to transaction database 54 within a defined time period, thus compensating a consumer's overall level of participation in growing the data set maintained by CDC system 36.

Other methods of determining compensation for participating consumers will occur to those of skill in the art and are intended to be within the scope of the present invention and it is presently preferred that two or more methods be employed so that a majority of participating consumers will receive some compensation in a relevant time period.

One of the functions of web portal 66 is to allow consumers to monitor the compensation they have earned from CDC service 36. A consumer can, at desired intervals, appropriately login to web portal 66 and view their account to see the compensation they have recently earned and the total compensation they have with CDC service 36. Web portal 66 can also provide the consumer with information about special offers which clients of CDC service 36 may make available to such consumers and/or other information and news of interest to the consumer.

It is contemplated that web portal 66 may also directly encourage consumers to increase their level of participation in CDC service 36 by, for example, adding transaction service providers 32 to those already specified by the consumer for their account. Web portal 66 can also inform consumers when CDC service 36 has added new transaction service providers 32 to those with which it can operate, to allow the consumers which interact with those new transaction service providers 32 to add those transaction service providers 32 to their account and to authorize CDC service 36 to access the corresponding transaction data.

It is also contemplated that, if desired, CDC service 36 can compensate for referrals by participating consumers of new (non-participating) consumers to CDC service 36. In such a case, a consumer who successfully refers a new (previously non-participating) consumer to CDC service 36 can be compensated for that referral with a one time payment, or with a percentage of the compensation that would be earned by the referred consumer in some period of time (i.e.—the first year of the new consumer's participation in CDC service 36) or in a variety of other manners. It is contemplated that, at least at the start up of CDC service 36, such referrals may provide a significant amount of compensation to participating consumers.

It is believed that the system and method of the present invention, as described herein, is unique and offers many advantages. By having consumers actively participate in the collection of consumer data, a unique and valuable database of consumer information can be obtained.

In particular, by having consumers actively provide detailed demographic information about themselves and combining that demographic information with transaction information obtained from a broad range of transaction services provides 32, the resulting database will provide invaluable consumer information for sales and marketing entities. Further, it is contemplated that CDC service 36 will maintain the data about participating consumers for relatively long periods of time, providing unique data mining opportunities for marketing and sales entities.

By appropriately compensating participating consumers, it is believed that a very diverse set of participating consumers will be obtained and that diverse and detailed consumer data, unavailable from any other single source, can be collected. Further, it is believed that consumers will continue to participate in the collection of their data for extended periods of time, increasing the value of the obtained data sets.

As should now be apparent, the present invention provides a method and system for obtaining, maintaining and using consumer information of interest including consumer demographic information and consumer transaction information. The information is obtained with the consent and participation of the consumers who are appropriately compensated for the use of their information. The system and method can obtain information directly from the consumers and from a variety of transaction service providers that the consumer interacts with.

By having active participation from the consumers, and by compensating the consumers for the use of their data, it is believed that a more comprehensive and better quality data set will be obtained than that available from other consumer information systems. Preferably, the compensation to the consumers is based upon each use of their data and thus compensation can be paid multiple times for the same data and may be earned over extended time periods, thus encouraging consumers to continue their participation in the system and method.

The system and method also provides feedback to marketers as to the effectiveness of their directed marketing effort using the system. A marketer can make an offer to a selected or specified group of consumers and the system and method can monitor the activities of consumers within the group to determine the uptake of the offer by the monitored consumers. This uptake information can be fed back to the marketer who can then, optionally, adjust the offer in an effort to improve its uptake, if necessary.

The above-described embodiments of the invention are intended to be examples of the present invention and alterations and modifications may be effected thereto, by those of skill in the art, without departing from the scope of the invention which is defined solely by the claims appended hereto.

We claim:

1. A method for collecting and using records of consumer information, where that information is verified for each consumer and the formation of redundant records is inhibited, comprising the steps of:
(i) creating an account for at least one consumer in a record in a demographic database, the account including demographic information relating to the at least one consumer and identifying at least one transaction service provider used by the at least one consumer;
(ii) obtaining authorization from the at least one consumer to utilize the provided demographic information and to obtain transaction information relating to transactions made by the at least one consumer via the identified at least one transaction service provider and to store that transaction information in a record in a transaction database;
(iii) in return for compensation from an entity, allowing that entity to specify criteria to define consumers of interest and to examine the records in the demographic database and the transaction database to identify consumers meeting the specified criteria;
(iv) forwarding information from the entity to the identified consumers; and
(v) providing compensation to each identified consumer.

2. The method of claim 1 wherein the entity is a commercial entity and the forwarded information comprises sales and/or marketing information believed to be of interest to the identified consumers.

3. The method of claim 1 wherein the at least one transaction service provider is a credit card company.

4. The method of claim 1 wherein the at least one transaction service provider is an electronic payment service.

5. The method of claim 1 wherein the at least one transaction service provider is a loyalty program.

6. The method of claim 1 wherein the at least one transaction service provider is a monitoring and reporting application installed by the at least one consumer onto a web-enabled device.

7. The method of claim 1 wherein the at least one transaction service provider is a social media site.

8. The method of claim 1 wherein the at least one transaction service provider is a location monitoring and reporting application installed by the at least one consumer onto a mobile phone.

9. The method of claim 1 wherein the at least one consumer must provide a predefined minimum set of demographic information relating to the at least one consumer and can optionally provide additional demographic information.

10. The method of claim 9 wherein the at least one consumer receives compensation for providing the additional demographic information.

11. The method of claim 1 wherein the forwarding of information to the identified consumers is achieved by receiving the information electronically from the entity and emailing the received information to the identified consumers such that the entity does not have access to the email addresses of the identified consumers.

12. The method of claim 1 wherein the forwarding of information to the identified consumers is achieved by receiving printed information from the entity and mailing the received information to the identified consumers such that the entity does not have access to the addresses of the identified consumers.

13. The method of claim 1 wherein each identified consumer receives a portion of the compensation received from the entity as the compensation of step (v).

14. The method of claim 1 wherein the compensation of step (v) comprises a discount for services and/or products offered by the entity.

15. The method of claim 1 wherein the forwarding of information to the identified consumers is achieved by receiving the information electronically from the entity and loading that information into corresponding social media accounts of the identified consumers.

16. The method of claim 1 wherein the identification of consumers provided to the entity maintains the anonymity of the consumers.

17. The method of claim 1 further including the steps of:
for each of the identified consumers, determining whether the identified consumer has acted on the forwarded information from the entity; and
informing the entity of at least the number of identified consumers who have acted on the forwarded information.

18. The method of claim 17 wherein the forwarded information comprises an offer to the identified consumers.

19. A system for collecting and using records of consumer information which is verified for each consumer to inhibit the formation of redundant records, comprising:
a consumer demographic database operable to receive and store records of demographic information relating to consumers participating in the system including, for each consumer, the identity of at least one transaction service provider used by the consumer;
a transaction database operable to receive and store records of transaction information, received from the transaction service providers identified in the consumer demographic database, for each participating consumer;
a data mining engine operable to, in response to an input data query, access information in records of the consumer demographic database and records of the transaction database to identify participating consumers who meet the conditions of the data query; and
a compensation engine cooperating with the data mining engine to assign compensation to participating consumers identified by the data mining engine in response to the data query.

20. The system according to claim 19 further comprising a web portal allowing participating consumers to access the system to determine the compensation they have been assigned by the compensation engine.

21. The system according to claim 19 further comprising a monitoring and reporting application which participating consumers can install on at least one web-enabled device to provide transaction information relating to the web based activities of the participating consumer to the transaction database.
